(19) United States
(12) Patent Application Publication
(10) Pub. No.: US 2016/0300549 A1
(43) Pub. Date: Oct. 13, 2016

(54) SPLICER, SPLICING DISPLAY SYSTEM AND SPLICING DISPLAY METHOD

(71) Applicant: BOE Technology Group Co., Ltd., Beijing (CN)

(72) Inventor: Zhiguo Zhang, Beijing (CN)

(21) Appl. No.: 15/079,319

(22) Filed: Mar. 24, 2016

(30) Foreign Application Priority Data
Apr. 10, 2015 (CN) 201510169584.X

(51) Int. Cl. G09G 5/00

(52) U.S. Cl. CPC G09G 5/006; G09G 2370/12; G09G 2360/04

(57) ABSTRACT

The present disclosure provides a splicer, a splicing display system and a splicing display method. The splicer includes an input module, a processing unit and a plurality of output ports. The input module is configured for obtaining display data of an image to be displayed. Each of the output ports is configured to be connected to a display device. The processing module is configured for detecting a connection state of each of the output ports and dividing the display data of the image to be displayed depending on the detecting result so as to obtain a display data block corresponding to each of the display devices connected to the plurality of output ports and send each display data block to the corresponding display device to display. The splicer is able to divide the image to be displayed automatically according to the connection state of each output port.

This application claims the benefit of Chinese Patent Application No. 201510169584.X filed on Apr. 10, 2015 in the State Intellectual Property Office of China, the whole disclosure of which is incorporated herein by reference.

### BACKGROUND OF THE INVENTION

1. Field of the Invention

Embodiments of the present disclosure relate to a display field, in particular, to a splicer and a splicing display system.

2. Description of the Related Art

With a successive development of display technology, a requirement for a large-size display panel in the market is gradually growing. However, the large-size display panel has a high cost and a low product yield. Thus, at present, a splicing display system is presented in the market, in which a plurality of display panels with small area are spliced into a whole piece of large-size screen and an image signal to be displayed is divided into a plurality of portions which are then transmitted to the respective display panels with small area to be displayed. However, an operation of the present splicing display system is complex, specifically, it is often required to perform a software control on a personal computer, a tablet computer or a cellphone to select the number of display panels to be spliced, a display manner or the like after a connection between hardwares is completed.

### SUMMARY OF THE INVENTION

A technical problem to be addressed by the present disclosure is how to solve a problem that the operation of the present splicing display system is complex.

In order to address the above problem, an embodiment of the present disclosure provides a splicer comprising:

an input module configured for obtaining display data of an image to be displayed;

a plurality of output ports, each of which being configured to be connected to a display device;

a processing module configured for detecting a connection state of each of the plurality of output ports and dividing the display data of the image to be displayed depending on the detecting result so as to obtain a display data block corresponding to each of the display devices connected to the plurality of output ports and send each display data block to the corresponding display device to display.

Further, the input module comprises an input port configured for connecting an external storage and a decoding unit configured for decoding a video source in the external storage to obtain the display data of the image to be displayed.

Further, the input port is a USB port.

Further, the processing module comprises:

a detecting unit configured for detecting the connection state of each of the plurality of output ports to obtain a serial number of each of the output ports connected to the display device;

a dividing unit configured for determining a dividing manner of the display data of the image to be displayed depending on the detected serial number and dividing the display data of the image to be displayed according to the dividing manner so as to obtain the display data block corresponding to each of the display devices connected to the plurality of output ports;

a sending unit configured for sending each display data block to the corresponding display device to display.

Further, the detecting unit comprises:

a receiving subunit configured for receiving a signal of the connection state itself sent by each of the output ports;

a judging subunit configured for judging whether the corresponding output port is connected to the display device depending on the signal of the connection state;

a detecting subunit configured for obtaining the serial number of the output port if the judging subunit judges that the output port is connected to the display device.

Further, the dividing unit comprises:

a storage subunit in which dividing parameters corresponding to combinations of the serial numbers of the output ports are stored;

an inquiring subunit configured for obtaining a corresponding dividing parameter from the storage subunit according to a combination of the serial numbers detected by the detecting unit;

a dividing subunit configured for dividing the display data of the image to be displayed according to the dividing parameter.

Further, the dividing unit further comprises:

an obtaining subunit configured for obtaining a definition of each of the display devices connected to the plurality of output ports;

a processing subunit configured for processing the data divided by the dividing subunit according to the definition obtained by the obtaining subunit so as to enable each of the display data blocks to be displayed on the corresponding display device in full screen.

Further, the output port is an HDMI port.

In order to address the above problem, another embodiment of the present disclosure provides a splicing display system comprising the splicer according to any one of the above embodiments and a plurality of display devices.

Further, the display device comprises a transparent display panel and a backlight source disposed at a backside of the transparent display panel.

Further, the plurality of display devices use a common backlight source.

According to another aspect of the present disclosure, it is provided a splicing display method using a splicing display system, the splicing display system comprising a plurality of display devices and a splicer comprising a plurality of output ports, the splicing display method comprising steps of:

connecting an external storage;

decoding a video source in the external storage to obtain display data of an image to be displayed;

detecting serial numbers of all the output ports which are currently connected to the display devices, and determining a number and a dividing manner of the display devices according to a combination of the detected serial numbers;

dividing the display data of an image to be displayed into corresponding number of display data blocks according to the determined dividing manner;

sending each of the display data blocks to a corresponding display device to display.

Further, the splicing display method further comprises: stretching each of the divided display data blocks to enable each of the display data blocks to be displayed on the corresponding display device in full screen.

With the splicer according to the embodiment of the present disclosure, a user is not required to select the number of screens to be spliced and the display manner by a software control after the connection between hardwares is completed, the splicer according to the embodiment of the present disclosure is able to divide the image to be displayed automatically according to the connection state of each output port so as to obtain a display data block corresponding to each display device. The splicer according to the embodiment of the present disclosure may be easily operated, and provide a user-friendly product.

### BRIEF DESCRIPTION OF THE DRAWINGS

FIG. 1 is a block diagram of a splicer according to an embodiment of the present disclosure;

FIG. 2 is a block diagram of the splicer of FIG. 1 with an input module comprising an input port and a decoding unit;

FIG. 3 is a block diagram of the splicer of FIG. 2 with a processing module comprising a detecting unit, a dividing unit and a sending unit;

FIG. 4 is a block diagram of the detecting unit according to an embodiment of the present disclosure;

FIG. 5 is a block diagram of the dividing unit according to an embodiment of the present disclosure;

FIG. 6 is a schematic diagram of a splicer according to an embodiment of the present disclosure;

FIG. 7 is a schematic diagram of a splicing display system comprising the splicer as shown in FIG. 6 according to an embodiment of the present disclosure.

### DETAILED DESCRIPTION OF PREFERRED EMBODIMENTS OF THE INVENTION

Specific implementations of the present disclosure will be further described in detail hereinafter in conjunction with embodiments and drawings. The following embodiments are used to explain the present disclosure, rather than to limit the scope of the present disclosure.

FIG. 1 is a block diagram of a splicer according to an embodiment of the present disclosure. The splicer comprises an input module 100, a processing module 200 and a plurality of output ports 300. The input module 100 is configured for obtaining display data of an image to be displayed. Each of the plurality of output ports 300 is configured to be connected to a display device. The processing module 200 is configured for detecting a connection state of each of the plurality of output ports 300 and dividing the display data of the image to be displayed depending on the detecting result so as to obtain a display data block corresponding to each of the display devices connected to the plurality of output ports and send each display data block to the corresponding display device to display.

With the splicer according to the embodiment of the present disclosure, a user is not required to select the number of screens to be spliced and the display manner by a software control after the connection between hardwares is completed, the splicer according to the embodiment of the present disclosure is able to divide the image to be displayed automatically according to the connection state of each output port so as to obtain a display data block corresponding to each display device. The splicer according to the embodiment of the present disclosure may be easily operated, and provide a user-friendly product.

In the embodiment, the input module is used to input the display data of the image to be displayed. The input module may directly employ an interface such as VGA, DVI, HDMI, etc., for example, a video source is processed into the corresponding display data by an external image processing device and the corresponding display data is then inputted by the input module.

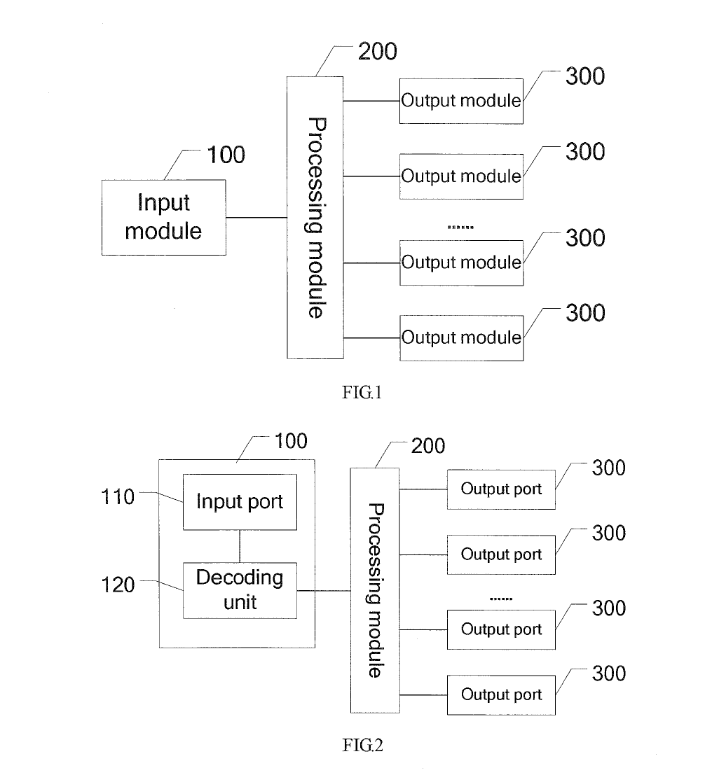

Preferably, the input module may also have a corresponding image processing function, so that the external image processing device is not needed. As shown in FIG. 2, the input module 100 comprises an input port 110 and a decoding unit 120. The input port 110 is configured to be connected to an external storage, and the decoding unit 120 is configured for decoding a video source in the external storage to obtain the display data of the image to be displayed. For example, the input port may be a USB port, to which an external storage such as a U-disk or mobile hard disk may be connected. The decoding unit may employ an ARM chip to realize a decoding operation on the video source in the external storage.

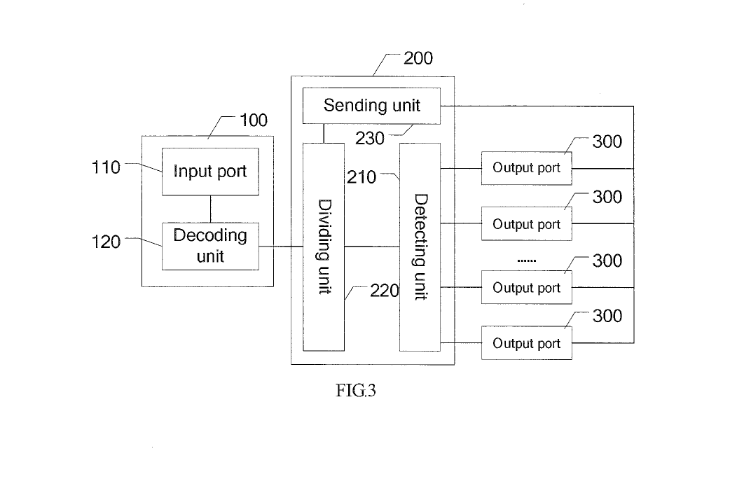

FIG. 3 is a block diagram of the splicer of FIG. 2 with the processing module comprising a detecting unit, a dividing unit and a sending unit. As shown in FIG. 3, the splicer comprises an input module 100, a processing module 200 and a plurality of output ports 300. The input module 100 is configured for obtaining display data of an image to be displayed, specifically, the input module 100 comprises an input port 110 and a decoding unit 120. Each of the plurality of output ports 300 is configured to be connected to a display device, for example, by using an HDMI port. The processing module 200 is configured for detecting a connection state of each of the plurality of output ports 300 and dividing the display data of the image to be displayed depending on the detecting result so as to obtain a display data block corresponding to each of the display devices connected to the plurality of output ports. The processing module 200 may be realized using an FPGA chip and may specifically comprise a detecting unit 210, a dividing unit 220 and a sending unit 230. The detecting unit 210 is configured for detecting the connection state of each of the output ports 300 to obtain a serial number of each of the output ports connected to the display device. The dividing unit 220 is configured for determining a dividing manner of the display data of the image to be displayed depending on the detected serial number and dividing the display data of the image to be displayed according to the dividing manner so as to obtain the display data block corresponding to each of the display devices connected to the plurality of output ports. The sending unit 230 is configured for sending each display data block to the corresponding display device to display.

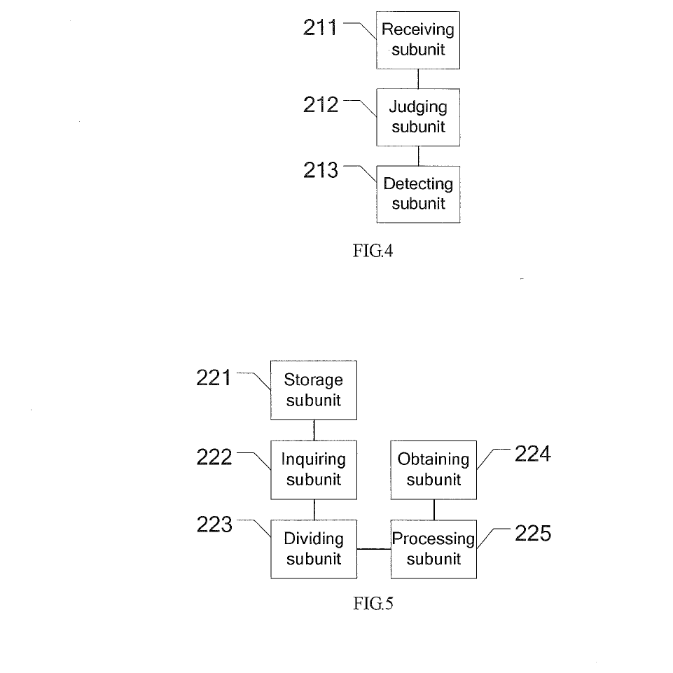

Further, FIG. 4 is a block diagram of the detecting unit according to an embodiment of the present disclosure. As shown in FIG. 4, the detecting unit 210 comprises a receiving subunit 211, a judging subunit 212 and a detecting subunit 213. The receiving subunit 211 is configured for receiving a signal of the connection state itself sent by each of the output ports. The judging subunit 212 is configured for judging whether the corresponding output port is connected to the display device depending on the signal of the connection state. The detecting subunit 213 is configured for obtaining the serial number of the output port if the judging subunit determines that the output port is connected to the display device.

In the embodiment, each output port has a unique serial number. If an output port is connected to a display device, the output port updates the connection state itself automatically and sends it to the receiving subunit 211 by way of signal. Then, the judging subunit 212 judges whether the output port is connected to the display device depending on the signal of the connection state. If the output port is connected to the display device, the serial number of the output port is obtained by the detecting subunit 213. In this way, the detecting unit 210 obtains the serial numbers of all the output ports which are currently connected to the display devices.

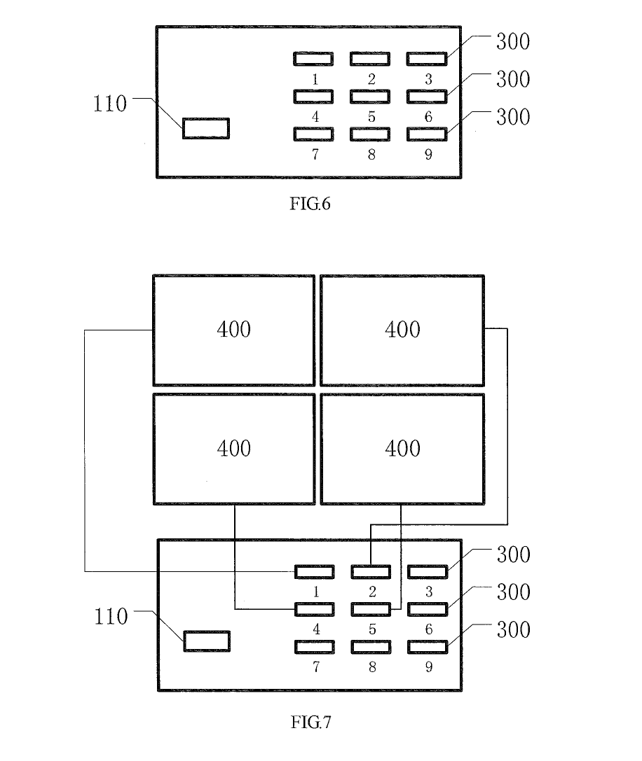

FIG. 5 is a block diagram of the dividing unit according to an embodiment of the present disclosure. As shown in FIG. 5, the dividing unit 220 comprises a storage subunit 221, an inquiring subunit 222 and a dividing subunit 223. Dividing parameters corresponding to various combinations of the serial numbers of the output ports are stored in the storage subunit 221. For example, in the case that the splicer has 9 output ports which are numbered from 1 to 9 in sequence as shown in FIG. 6, there are 512 (ninth power of 2) combinations of the connection states of all the output ports at the same time. Each of the combinations corresponds to one of the connection states of all the output ports of the splicer at the same time. A set of dividing parameters may be provided with regard to each combination of the connection states. The display data of a frame of the image can be divided into corresponding display data blocks with the dividing parameters. In addition, in order to facilitate connecting the various spliced display devices to the correct output ports by the user, position relationships among the output ports of the various display devices correspond to position relationships among the various spliced display devices, so that the number and the arrangement mode of the connected display devices can be obtained only from the serial numbers of the output ports. The inquiring subunit 222 is configured for obtaining a corresponding dividing parameter from the storage subunit according to a combination of the serial numbers detected by the detecting unit. The dividing subunit 223 is configured for dividing the display data of the image to be displayed according to the dividing parameter.

Preferably, the dividing unit 220 further comprises an obtaining subunit 224 and a processing subunit 225. The obtaining subunit 224 is configured for obtaining a definition of each of the display devices connected to the plurality of output ports. The processing subunit 225 is configured for processing the data divided by the dividing subunit according to the definition obtained by the obtaining subunit so as to enable each of the display data blocks to be displayed on the corresponding display device in full screen.

Next, an operation process of the splicer according to the embodiment of the present disclosure will be described in detail in connection with FIGS. 6 and 7.

The splicer according to the embodiment of the present disclosure is powered and initialized, the video source in the external storage is then decoded by the input module to obtain the display data of the image to be displayed. The processing module detects the serial numbers of all the output ports which are currently connected to the display devices and determines the number and the dividing manner of the display devices according to the combination of the detected serial numbers so as to divide the display data of the image to be displayed into a corresponding number of data blocks according to the determined dividing manner, then to stretch each of the divided data blocks into full high definition (FHD), so that each of the data blocks can be displayed on the corresponding display device in full screen. For example, by means of the splicer as shown in FIG. 6, any of splicing modes within 3×3 may be realized. As long as the splicing number and the splicing mode of the display devices is identified by the user, each of the display devices may be connected to the corresponding output port so as to stretch an image source into full screen. For example, four display devises 400 are spliced as shown in FIG. 7, then are connected to the output ports numbered 1, 2, 4, 5 respectively according to their position relationship; the splicer detects that the output ports numbered 1, 2, 4, 5 are connected to the display devices, and divides the same frame of the image into four portions including a left-upper portion, a right-upper portion, a left-lower portion and a right-lower portion according to the dividing parameter corresponding to the combination of the serial numbers of the four output ports, then sends the display data of the left-upper portion into the output port numbered 1, the display data of the right-upper portion into the output port numbered 2, the display data of the left-lower portion into the output port numbered 4, and the display data of the right-lower portion into the output port numbered 4, so that an integrated image is displayed on the spliced large screen.

Further, an embodiment of the present disclosure provides a splicing display system comprising the splicer as stated above and a plurality of display devices.

Preferably, in order to improve the display effect of the plurality of spliced display devices, each of the display devices may employ a transparent display panel, and each transparent display panel may be provide with a separate backlight source at its backside. Preferably, a large size backlight source may be employed and the plurality of display devices may share one backlight source, so that a difference in brightness among the transparent display panels may be reduced and the display effect may be improved.

The above implementations are merely used to explain the present disclosure, rather than to limit the present disclosure. Various changes and variants may be made by those skilled in the art without departing from the spirit and scope of the present disclosure. Thus, all the equivalent technical solutions are also included in the scope of the present disclosure. Therefore, the scope of the present disclosure shall be defined by the claims.

What is claimed is:

1. A splicer, comprising:
an input module configured for obtaining display data of an image to be displayed;
a plurality of output ports, each of which being configured to be connected to a display device;
a processing module configured for detecting a connection state of each of the plurality of output ports and dividing the display data of the image to be displayed depending on the detecting result so as to obtain a display data block corresponding to each of the display devices connected to the plurality of output ports and send each display data block to the corresponding display device to display.

2. The splicer of claim 1, wherein the input module comprises an input port configured to be connected to an external storage and a decoding unit configured for decoding a video source in the external storage to obtain the display data of the image to be displayed.

3. The splicer of claim 2, wherein the input port is a USB port.

4. The splicer of claim 1, wherein the processing module comprises:
a detecting unit configured for detecting the connection state of each of the plurality of output ports to obtain a serial number of each of the output ports connected to the display device;
a dividing unit configured for determining a dividing manner of the display data of the image to be displayed depending on the detected serial number and dividing the display data of the image to be displayed according to the dividing manner so as to obtain the display data block corresponding to each of the display devices connected to the plurality of output ports;
a sending unit configured for sending each display data block to the corresponding display device to display.

5. The splicer of claim 4, wherein the detecting unit comprises:
a receiving subunit configured for receiving a signal of the connection state itself sent by each of the output ports;
a judging subunit configured for judging whether the corresponding output port is connected to the display device depending on the signal of the connection state;
a detecting subunit configured for obtaining the serial number of the output port if the judging subunit determines that the output port is connected to the display device.

6. The splicer of claim 4, wherein the dividing unit comprises:
a storage subunit in which dividing parameters corresponding to various combinations of the serial numbers of the output ports are stored;
an inquiring subunit configured for obtaining a corresponding dividing parameter from the storage subunit according to a combination of the serial numbers detected by the detecting unit;
a dividing subunit configured for dividing the display data of the image to be displayed according to the dividing parameter.

7. The splicer of claim 6, wherein the dividing unit further comprises:
an obtaining subunit configured for obtaining a definition of each of the display devices connected to the plurality of output ports;
a processing subunit configured for processing the data divided by the dividing subunit according to the definition obtained by the obtaining subunit so as to enable each of the display data blocks to be displayed on the corresponding display device in full screen.

8. The splicer of claim 1, wherein the output port is an HDMI port.

9. A splicing display system, comprising the splicer of claim 1 and a plurality of display devices.

10. The splicing display system of claim 9, wherein the display device comprises a transparent display panel and a backlight source disposed at a backside of the transparent display panel.

11. The splicing display system of claim 10, wherein the plurality of display devices use a common backlight source.

12. A splicing display method using a splicing display system, the splicing display system comprising a plurality of display devices and a splicer comprising a plurality of output ports, the splicing display method comprising steps of:
connecting an external storage;
decoding a video source in the external storage to obtain display data of an image to be displayed;
detecting serial numbers of all the output ports which are currently connected to the display devices, and determining the number and a dividing manner of the display devices according to a combination of the detected serial numbers;
dividing the display data of the image to be displayed into corresponding number of display data blocks according to the determined dividing manner;
sending each display data block to a corresponding display device to display.

13. The splicing display method of claim 12, further comprising: stretching each divided display data block to enable each display data block to be displayed on the corresponding display device in full screen.
